(19) United States
(12) Patent Application Publication
(10) Pub. No.: US 2012/0270636 A1
(43) Pub. Date: Oct. 25, 2012

(54) METHOD OF PRESENTING AND PLAYING A REPEAT OUTCOME GAME

(76) Inventor: Elia Rocco Tarantino, Las Vegas, NV (US)

(21) Appl. No.: 13/458,873

(22) Filed: Apr. 27, 2012

Related U.S. Application Data
(63) Continuation of application No. 12/945,482, filed on Nov. 12, 2010, now abandoned.
Application No. 12/945,482 is a continuation-in-part of application No. 12/456,615, filed on Jun. 18, 2009.
Application No. 12/456,615 is a continuation-in-part of application No. 11/729,092, filed on Mar. 27, 2007, now abandoned.
Application No. 11/729,092 is a continuation-in-part of application No. 11/406,814, filed on Apr. 19, 2006, now Pat. No. 7,740,245.

(51) Int. Cl. A63F 13/00

(52) U.S. Cl. 463/22

(57) ABSTRACT

In a method of presenting or playing a wagering game, if a winning outcome is received in the play of a first game, a first award is awarded and the awards associated with one or more winning outcomes for the game are then enhanced for potential award in a subsequent game or games. In one embodiment, a base pay table or award structure is modified or enhanced, such as by adjusting awards or associating multipliers or bonus values such as progressive awards, to create an enhanced pay table or award structure. The game offers a player an enhanced award if a winning outcome that is received in a first game is repeated within a defined number of subsequent games.

### RELATED APPLICATION DATA

This application is a continuation of U.S. patent application Ser. No. 12/945,482, filed Nov. 12, 2010, which is a continuation-in-part of U.S. patent application Ser. No. 12/456,615, filed Jun. 18, 2009, which is a continuation-in-part of U.S. patent application Ser. No. 11/729,092, filed Mar. 27, 2007, now abandoned, which is a continuation-in-part of U.S. patent application Ser. No. 11/406,814, filed Apr. 19, 2006, now U.S. Pat. No. 7,740,245 issued Jun. 22, 2010.

### FIELD OF THE INVENTION

The present invention relates to games offering opportunities for awards and, more particularly, wagering type games.

### BACKGROUND OF THE INVENTION

Wagering games continue to increase in popularity. As such, new games continue to be developed. In general, it is desirable to develop games which are interesting to players. In some instances, the entire format of the game is changed. For example, entirely new games are sometimes developed. In other situations, existing games are modified or enhanced. Such a modification may be a change in the method of game play.

One popular game feature is the “bonus.” In general, most games offer basic payout or winning award for a winning outcome. It has been found, however, that many players enjoy the opportunity to continue play or to be paid enhanced winnings. In a very common game configuration, a game defines a number of predetermined winning outcomes. For one or more of those outcomes, the player is either provided the opportunity to play a “bonus round” as part of that same game for the opportunity to win a bonus award, or is directly paid a larger award.

These award structures are still very limited in their excitement. For example, the offering of such bonuses do little to entice a player to play additional games. In addition, these bonus structures are pre-set, meaning that they are the same every time. For example, a player of a game offering a bonus level generally must obtain a particular winning set of symbols for a chance to play the bonus round. That particular set of symbols does not change. In addition, these bonuses are often known before play of the game begins. For example, when a player initiates a game, they may be informed that they will be entitled to a 2× bonus for all wins.

A wagering game which is exciting to players and which is beneficial to casinos is desirable.

### SUMMARY OF THE INVENTION

The present invention comprises methods of playing and presenting games, including apparatus and systems for presenting games.

In one embodiment of a method of presenting a game, if a winning outcome is received in the play of a first game, a first award is awarded and one or more awards associated with one or more winning outcomes for the game are then enhanced for potential award in a subsequent game or games. In a preferred embodiment, the award for the particular winning outcome of the first game is enhanced to a value greater than its first or normal value. Preferably, if the same winning outcome is received (i.e. is repeated) in the one or more subsequent games, the enhanced award is awarded and the one or more enhanced values are then returned to their original values. In addition, in a preferred embodiment, if the winning outcome is not received in a predetermined number of subsequent games, the one or more enhanced values are returned to their original values.

In one embodiment, awards are enhanced by increasing them. Awards may be increased in absolute value, by application of a multiplier, by addition of a bonus or in other manners. In one embodiment, an award is enhanced by doubling its value. In certain embodiments, awards are increased by adjusting a pay table of winning results and associated payouts or awards. In one embodiment, the awards may be progressive in nature, such as funded by specific additional wagers placed by one or more players.

In one embodiment, the enhanced award(s) remains in effect for at least one subsequent game. The enhanced award(s) may remain in effect for multiple games, such as a random number of subsequent games. Other awards may be enhanced if winning outcomes are received in the one or more subsequent games. In one embodiment, the amount of an enhanced award, such as the size of a multiplier, may decrease from its enhanced value to an original value.

The game which is presented may be a game of video poker having a plurality of predetermined winning outcomes associated with a set of first awards. If the outcome of a first game is a winning hand, the award for that hand may be increased from a first value to a second value. This second value may remain in effect until the player either receives the same winning hand or a predetermined number of games are presented or played without receiving that hand.

In accordance with the method of the invention, receipt of a winning outcome in one game triggers the opportunity for a larger award if that outcome can be repeated in one or more subsequent games. In this manner, if a player wins a first game, they are enticed to play one or more additional games in an attempt to win a larger award for receiving the winning outcome in the later game(s).

Further objects, features, and advantages of the present invention over the prior art will become apparent from the detailed description of the drawings which follows, when considered with the attached figures.

### DESCRIPTION OF THE DRAWINGS

FIG. 1 illustrates an exemplary gaming machine for use in accordance with a game of the invention;

FIG. 2 is a flow diagram illustrating a method of game presentation/play in accordance with an embodiment of the invention;

FIG. 3 illustrates an example of a base pay table or award structure, a particular game outcome and a variety of enhanced pay tables or award structures which may be yielded in accordance with a game of the invention;

FIG. 4 illustrates an example embodiment of the invention wherein multiple enhanced award opportunities overlap one another;

FIG. 5 illustrates an example embodiment of the invention wherein one or more enhanced awards comprise progressive pools or awards;

FIG. 6 illustrates an example embodiment of the invention wherein various winning outcomes may have base awards, including one or more outcomes with progressive awards, and wherein enhanced awards are enabled with enhanced wagers;

FIGS. 7A and 7B illustrate a surrender feature of the present invention; and

FIG. 8 illustrates an example embodiment wherein a triggering outcome has no associated initial award.

### DETAILED DESCRIPTION OF THE INVENTION

The invention comprises methods of presenting and playing games, as well as apparatus for implementing the method(s). In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises methods of presenting and playing games. One aspect of the invention is a wagering game offering a player an opportunity for winnings for one or more predetermined winning outcomes. In the event of a winning outcome, the game offers an opportunity for an enhanced award for one or more winning outcomes in one or more subsequently played games. In one embodiment, a winning outcome of a game causes one or more base or normal awards to increase. A player may play one or more subsequent games and, if a winning outcome associated with one or more of the increased awards is received, the player is awarded that increased award.

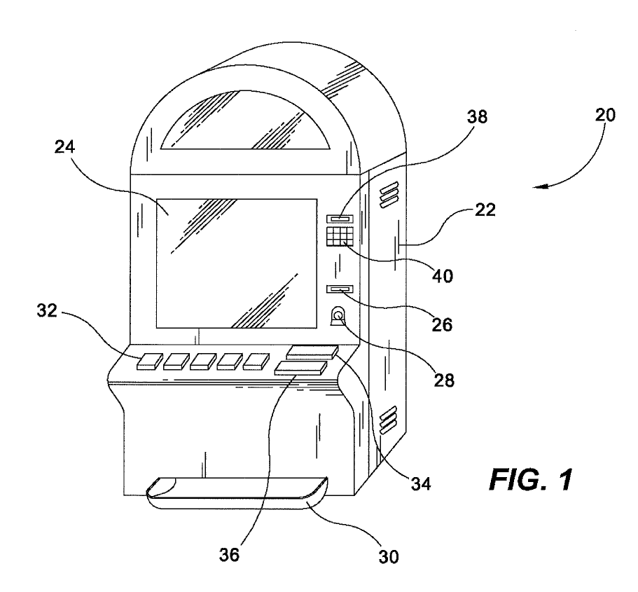

In one embodiment, the one or more games of the invention are implemented by and presented to a player with a gaming machine. FIG. 1 illustrates a gaming machine 20 in accordance with one embodiment of the invention. As illustrated, the gaming machine 20 includes a housing 22 for enclosing/supporting various components of the gaming machine. The gaming machine 20 may include one or more display devices, such as a video display 24, for displaying game information. This information may comprise, as detailed below, images of cards or other indicia, and associated game information such as a pay table. Speakers (not shown) or other devices may be provided for generating sound associated with the game.

In one embodiment, the game is played as a wager-type game which requires that a player place a bet or wager to play the game. As illustrated, the gaming machine 20 may include one or more devices or means for accepting value, such as a bill validator/acceptor 26 for accepting paper currency and/or a coin acceptor 28 for accepting coins. Other means of accepting value for wagering, such as a credit card reader or a ticket reader, may be provided. The player may wager some or all of this value, such as by providing input regarding a wager (such as by pressing a “bet one” or “bet max” button, which effectuates placing a wager from the provided value).

Preferably, if the player is a winner of the game, then the player is provided an award. The award may comprise physical monies, such as bills or coins, or may comprise representative value, such as credits. An award of winnings in the form of coins may be paid to the player via a coin tray 30. Value may also be provided to the player by a printed receipt, a card or the like, as is well known in the art of “cashless” gaming.

Preferably, the gaming machine 20 includes means for a player to provide input. In one embodiment, this means comprises one or more buttons. For example, a plurality of card “hold” or “select” buttons 32 may be provided for permitting a player to hold/select cards in a hand. A deal/draw button 34 permits a player to indicate that they wish the game to start or to draw replacement cards. A bet button 36 is provided for a player to select the amount to bet on a particular game. Other or additional types of input devices may be utilized, such as a touch-screen, joystick, rotating arm or the like.

A game controller (not shown) is provided for controlling the various devices of the gaming machine and for providing game information. For example, the game controller may be arranged to generate video and audio data for presentation by the display 24 and speakers of the gaming machine 20. The game controller may be arranged to detect a signal from the coin acceptor indicating the receipt of coins or other value, and may be arranged to cause a coin delivery mechanism to deliver coins from a coin hopper to the coin tray 30, or otherwise credit or dispense winnings. The controller may also be configured to detect the placing of a wager and then present a game in response thereto. The game controller may be configured to accept game data generated at a remote location, such as a remote server, and effect presentation of a game using that data.

In one or more embodiments, the game controller may execute one or more instructions, programs, software modules, or the like to control various devices of the gaming machine or to provide game information. The one or more instructions, programs, software modules, or the like may be stored on a storage medium (such might comprise a data storage or memory device such as ROM, RAM, a hard drive or the like) within or accessible by the game controller. The instructions may comprise, for example, machine readable code configured to affect the steps/features of the game play/presentation methods detailed herein.

The game controller may include a random number generator or the gaming device may include a separate random number generator or be in communication with one in some embodiments. The random number generator may be a device within the controller used to generate random game results or outcomes. The random number generator may be configured to provide one or more random numbers to facilitate the play of one or more games. As is known, random numbers are commonly used in wagering games to provide an outcome of a game.

The random number generator may accept one or more seed values in one or more embodiments from which one or more random numbers may be generated. The seed value may represent various tangible objects or characteristics. For example, a measurement of vibration, temperature, voltage, or time may be used as a seed value. It is noted that the random number generator may include or be connected to one or more sensors or the like to measure these or other values for use as seed values. It is also noted that in server based gaming environments, the random number generator may be remote from one or more gaming machines and that the random numbers generated by the random number generator may be communicated to the gaming machines and/or that game outcomes may be provided to the gaming machine.

It will be appreciated that the gaming machine 20 may have a variety of configurations and the gaming machine 20 illustrated and described above is but an example of a device for implementing the game of the present invention. For example, the gaming machine 20 may include one or more rotating reels, as is common to “slot”-type machines. The gaming machine 20 may be associated with a network and receive game information remotely and may transmit information, such as payout and game play information, to a remote location. Such a network may include one or more wireless or wired communication links.

The gaming machine 20 may also have other forms than that illustrated. For example, the gaming machine 20 might comprise a computing device, such as a home computer. The home computer may be configured to receive game information over the Internet or other communication link to a game server. The gaming machine 20 might also comprise a hand-held device such as a mobile telephone or PDA.

As will be appreciated later, the game of the invention may also be presented via other than a gaming machine. For example, the game may be presented as a “table” game.

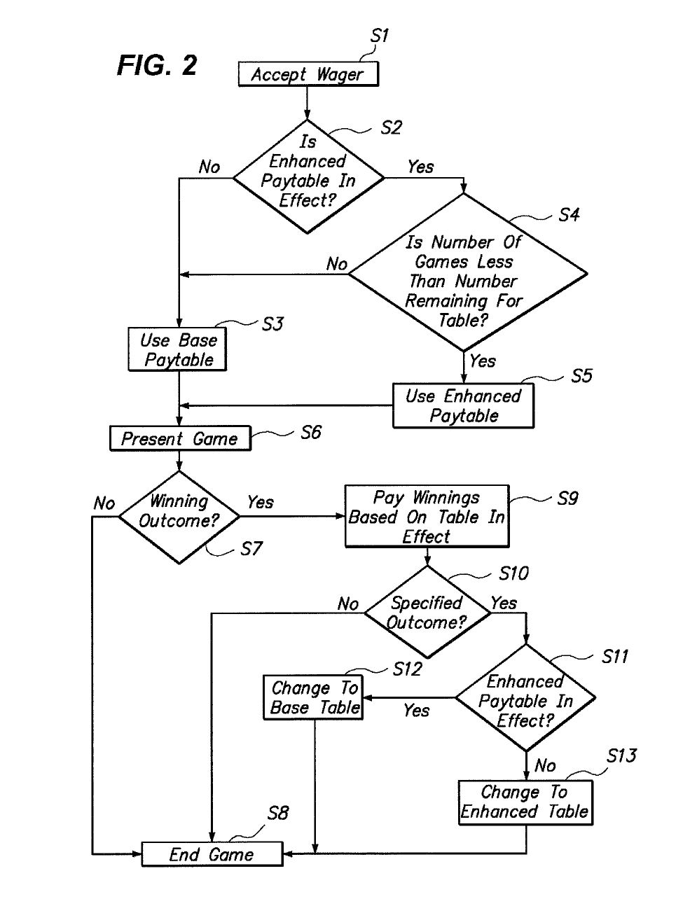

One aspect of the invention comprises methods of playing or presenting games. One embodiment of a method of presenting a game will be described with reference to FIG. 2.

As indicated above, in a preferred embodiment, a game of the invention is a wagering type game. As such, in a step 51, the game preferably includes the step of accepting a wager. The wager may be accepted from a player. In one embodiment, the step of accepting a wager comprises two components. First, a player provides value. Second, the player designates a portion of that value to comprise a wager. For example, a player my provide coins, bills, a value ticket or other value or source of value. In the case of a gaming machine, that value or source of value may be input to the machine. In the case of a gaming table, that value or source of value might be provided to a dealer. In the case of a gaming machine, the value may be represented as credits. The player may then wager some or all of those credits, such as by providing a “wager” input such as depressing a “bet one” or “bet max” button. In the case of a table game, the player value may be represented by gaming chips. The player may place a wager by transferring one or more of those chips to the game provider (such as a dealer).

In a step S2, the method preferably includes the step of determining if a base or enhanced pay table or award structure is in effect. If not, then a base pay table is preferably utilized, as in step S3. Such a base pay table might be stored in a memory or other data storage device of the gaming machine. If so, then in a step S4, it is determined if that enhanced pay table or award structure is to remain in effect. If not, then the base pay table or award structure is preferably utilized. If so, then the enhanced pay table or award structure is utilized, as in step S5. Such an enhanced pay table might also be stored in a memory or other data storage device of the gaming machine.

In one embodiment, as detailed below, the criteria for determining whether an enhanced pay table or award structure remains in effect may vary. For example, such criteria may depend upon the number of games played after a particular enhanced pay table or award structure is placed into effect or the outcome of one or more games.

Regardless of which pay table or award structure is utilized (i.e. in steps S3 or S5), in a step S6, a game is presented to one or more players. The game may be of a variety of types. For example, the game may be a video-poker game, a slot-type game, a table game such as poker or blackjack, or other games now known or later developed. The presentation of the game may include the presentation of game information, such as the display of video-generated card images, the rotating of reels to display slot indicia, the dealing of physical cards or the like. The presentation of the game may alternatively or, in addition, comprise the acceptance of various inputs from the player(s). For example, a player may press a “deal” button of a gaming machine to cause cards to be displayed, and may press one or more “hold/draw” buttons to cause cards to be replaced (as in the case of “draw” type poker).

Preferably, the game presented to the player has at least two outcomes. One or more, but preferably not all, of those outcomes are designated winning outcomes. Each winning outcome has an associated award. The awards may the same or different. In one embodiment, the awards comprise credits which are representative of monetary value.

In a step S6, the outcome of the game is determined. This preferably comprises determining whether the outcome of the game is one of the predetermined winning outcomes (or is otherwise a “non-winning” or “losing” outcome). If the outcome of the game is not a winning outcome (i.e. a “losing” outcome), then the game preferably ends at step S8. In one embodiment, in such instance, the player loses or forfeits their wager.

If the outcome of the game is a winning outcome, then in a step S9, the player is preferably awarded winnings for that outcome. The winnings may be defined by a pay table of winning outcomes and associated awards. As indicated above, the particular pay table or other award structure which is in effect may vary. As also indicated above, such an award may comprise an award of credits, monies or other prizes or the like.

In a step S10, in one embodiment, it is determined if the winning outcome is a “game changing” outcome. If not, then the game ends, as in step S8. As will be appreciated in more detail below, such an outcome may be one which “deactivates” an enhanced pay table or award structure, or one which causes an enhance pay table or award structure to be implemented.

In step S11, it is determined if the winning outcome is “gaming changing”, then it is determined if an enhanced pay table or award structure is in effect. If so, then in step S12, a change is preferably made back to the base pay table or award structure. If not, then a change is preferably made to the enhanced pay table or award structure, as in step S13.

Thereafter, the game preferably ends, as in step S8.

It will be appreciated that the above-referenced description represents one embodiment of a game. The game may have other features and may be implemented in other fashions. For example, the game may be implemented using a “flow” or logic which differs from that detailed above.

Some particular examples of methods of presenting and playing games in accordance with the invention will now be described. These examples will provide additional insight into various aspects of the invention.

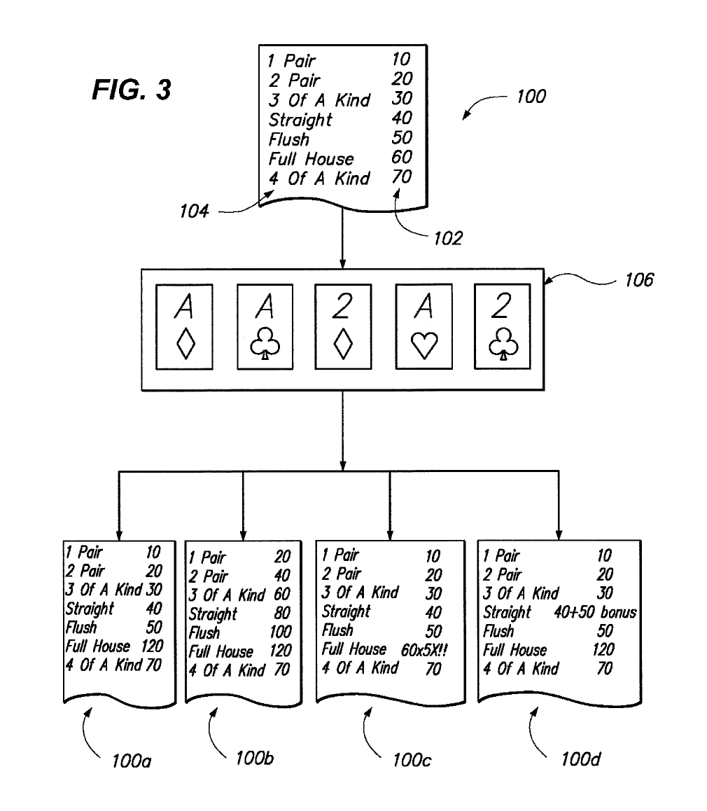

Referring to FIG. 3, in one embodiment, a game may have a base pay table or award structure 100. In the case of a video poker game, the pay table may provide for the award of winnings 102 for various predetermined winning poker hands 104. As illustrated, such hands or outcomes 104 might comprise One Pair (such as a pair of Jacks or better), Two Pair, Three of a Kind and the like. Of course, the particular outcomes which are designated as winning may vary, such as depending upon the particular game which is being presented.

As illustrated, each predetermined winning outcome 104 preferably has an associated winning award 102. The base or normal award for each winning outcome 104 may be defined by a base pay table. The awards may comprise, for example, a number of credits representative of monetary value.

A player may play the game and receive an outcome 106. As detailed above, the player is preferably required to place a wager in order to the play the game. Where the game is a game of video poker, the outcome of the game may comprise a poker hand. As illustrated, the outcome is a hand of 5 poker cards. Of course, the outcome of the game will depend upon the particular game which is being presented. Generally, the game has a plurality of outcomes and some, but not all, of those outcomes are defined as winning outcomes. In other embodiments, all outcomes could be defined as winning outcomes but the awards associated therewith may vary greatly.

If the outcome of the game is a losing outcome (i.e. is not one of the identified winning outcomes), the game may end. Preferably, this causes the player to lose their wager and not be awarded any winnings.

As indicated above, if the outcome of the game is a winning outcome, then the player is preferably awarded an award. In the illustrated example, the outcome of the game is a Full House poker hand. The player is preferably awarded 60 credits in accordance with the pay table or award structure 100 which was then in effect during play of that game.

Next, it is determined if the winning outcome is a specific or predetermined outcome. Such an outcome may be referred to as a “triggering” outcome, as described below. If one embodiment, a specified outcome comprises one or more of the predetermined winning outcomes. For example, a specified outcome might comprise all winning outcomes from One Pair up through a Full House (thus excluding winning hands such as Four of a Kind). In another embodiment, the specified outcomes may comprise any of the winning outcomes.

If so, then it is determined if the pay table or award structure is preferably changed. In one embodiment, referring to FIG. 3, in the event the base pay table or award structure is active and a specified winning outcome is received, then a different pay table or award structure is activated. Preferably, the different pay table or award structure comprises an enhanced pay table or award structure, wherein the award associated with at least one winning outcome is enhanced to a value which is greater than its normal award as defined by the base pay table or award structure.

FIG. 3 illustrates various different pay tables or award structures which may be activated. In a first embodiment, the new pay table or award structure 100a may include a different payout or award for the particular winning/triggering outcome which was just received. In the example provided where the outcome was a Full House poker hand, the award for that particular outcome may be adjusted. Preferably, the adjustment is an increase in the size or value of the award. In a most preferred embodiment, the increase is at least a doubling of the award. For example, where the base award was 60 credits for a Full House poker hand, the new award may be 120 credits. In another embodiment, the new pay table or award structure 100b may include different payouts or awards for various outcomes. In one embodiment, the award associated with the outcome just received and all others of lesser rank or award than that just received may be adjusted. In the example provided where the outcome was a Full House poker hand, then the awards associated with that outcome and all other winning hands of lower ranks are adjusted. Preferably, the adjustment is an increase and most preferably an increase of at least 2 times the original or base award. In one embodiment the amount by which the particular awards are adjusted need not be the same.

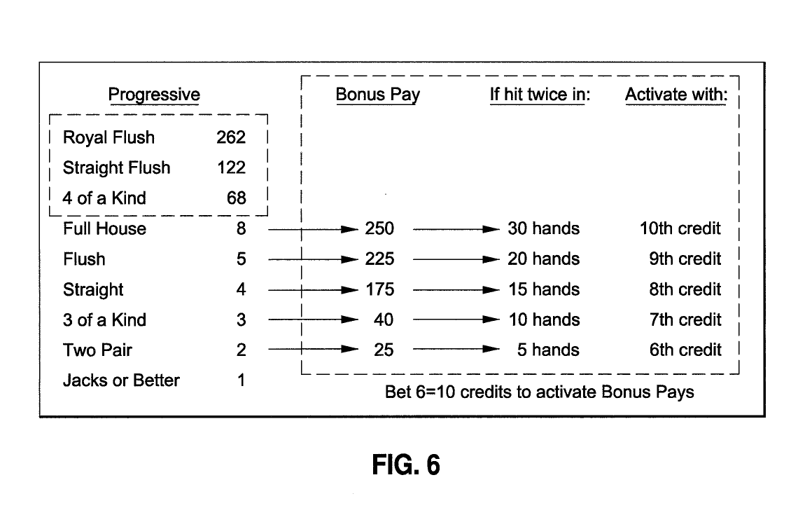

As will be appreciated, the enhanced award structure may comprise a modified or enhanced pay table, or it might comprise other types of enhanced awards. For example, as detailed herein, an enhanced pay table may comprise a pay table of outcomes having associated awards, those awards varying from those in a base pay table. In other embodiments, such as illustrated in FIG. 6 below, enhanced awards may comprise bonus awards. Other enhanced awards may comprise multipliers or the like (such multipliers may be applied to a base pay table, whereby a new pay table is not used but an enhanced award is realized by the application of the multiplier to the base award defined by the pay table).

It will be appreciated that different rules may apply to the particular specific outcomes. For example, when one particular specified outcome is received, it may be that the new pay table or award structure is adjusted only as to that particular award. However, if another specified award is received, the pay table or award structure may be adjusted as to awards associated with multiple different outcomes.

In one embodiment, if a player receives a triggering outcome, the player may be required to obtain the same outcome in order to receive an enhanced award (i.e. the only outcome having an enhanced award is the triggering outcome; all other winning outcomes continue to have their base award). In other embodiments, enhanced awards may be provided for various outcomes and once the player receives a triggering outcome, the player could select a second outcome that they wish to play for (for example, in the game of video poker the player might receive a triggering Full House outcome and then be offered a table of outcomes with associated enhanced awards, such as enhanced awards for Two Pair, Full House, Four of a Kind, etc., and the player may elect to play (such as providing input of one such selection) for one of those outcomes (even though it is not the same as the triggering outcome).

In another embodiment, the triggering outcome and the outcome which must be repeated need not be exactly the same. For example, in the video poker game Double-Double, different Four of a Kind winning hands have different associated awards. For example, a Four of a Kind winning hand comprising A, A, A, A, 2 has a higher award than the Four of a Kind hand comprising J, J, J, J, 4. In one embodiment, regardless of the winning outcome which comprises the triggering outcome, the player may receive any specified enhanced winning outcome for an enhanced award. For example, in the poker game of Double-Double detailed above, the player might be awarded an enhanced award for receiving any Four of a Kind hand in the predetermined subsequent number of games to receiving one of the specific triggering Four of a Kind hands. The award for the “repeat” hand may be enhanced to be higher than the award for the highest paying triggering hand (for example, if the Four of a Kind hand A, A, A, A, 2 pays 400 credits and the hand J, J, J, J, 4 pays 100 credits when received as a triggering hand and the player receives the J, J, J, J, 4 as the triggering outcome, then the player may be awarded 500 credits (more than the highest base award for a Four of a Kind) if the player receives any Four of a Kind outcome during the subsequent number of games/hands).

The pay table or award structure may be adjusted in a variety of ways. In one embodiment, the particular award values associated with one or more outcomes may be changed. Referring to FIG. 3, in one embodiment the base award value may remain the same but the pay table or award structure 100c may include a multiplier. The multiplier may apply to a particular award or multiple awards. Still referring to FIG. 3, in one embodiment the base award value may remain the same but the pay table or award structure 100d may include one or more bonus amounts or values. Again, the bonus value or values may apply to a particular award or multiple awards.

It will be appreciated that the pay tables or awards need not be in a “table” form but are simply one way to illustrate that the particular award or value for one or more outcomes has been changed and that, should that outcome be received when playing a future game, the player would be awarded the corresponding “new” or enhanced amount.

In one embodiment, once a new pay table or award structure is in effect, a player has an opportunity to be awarded an award in accordance with that new pay table or award structure via the play of one or more subsequent games. In one embodiment, the new pay table or award structure remains in effect until the player receives a specified outcome. Preferably, once the player receives the same specified outcome which caused the new pay table or award structure to go into effect, that same specified outcome causes the base or old pay table or award structure to go back into effect, as in steps S11 and S13 of the flow diagram described above. For example, if a player received a specified winning outcome of a Full House, the player might be awarded 60 credits and the pay table or award might be changed so that the next occurrence thereof entitles the player to an award of 120 credits. Upon the next game play occurrence in which the player received another Full House outcome, the player would be paid 120 credits and the old pay table or award structure (providing for payment of 60 credits) would go back into effect.

In one embodiment, as detailed in step S4 of the flow diagram illustrated in FIG. 2, the game may be configured so that the new pay table or award structure remains in effect only for a certain number of subsequent games or plays. For example, the new pay table or award structure may remain in effect only for the next 3 or 5 games (or any other number of games), rather than until the specific outcome is received again. However, in such an embodiment, the new pay table or award structure is preferably still deactivated if the player receives a winning outcome having an associated enhanced award before the predetermined number of games are played (for example, a player may be given a maximum of 5 subsequent games or hands to achieve a repeated winning poker hand, such as a Full House, and if the player receives such a repeated outcome on the second subsequent hand, the enhanced pay table or award structure preferably reverts or deactivates and does not remain in effect for the remaining three hands).

Of course, the new pay table or award structure might remain in effect only for a certain period of time or based upon other criteria. For example, if a player received a Full House and the pay table or award structure was changed, the player might be provided only 5 games to receive another Full House outcome or else the pay table or award structure would revert back to the base paytable or award structure.

As indicated above, the number of games an enhanced pay table or award structure remains in effect may be predetermined, such as 3 subsequent games, in all cases. In other embodiments, however, the number of games an enhanced pay table or award structure remains in effect (i.e. the number of subsequent games in which a player has an opportunity to obtain a repeat win) may be determined randomly. In one embodiment, the number of games may be randomly selected from between a minimum and maximum number of games. For example, the number of games may be a number of games between 1 and 10 games, selected randomly. Preferably, the number of subsequent games the player has to repeat a winning outcome is displayed to the player.

Random selection of the number of games may benefit a player during a game. For example, there may be a relatively high likelihood of repeating a specific outcome within a particular number of hands. If the random selection provides approximately this number of hands, or more, to repeat the specific outcome, the player will have a high likelihood of obtaining the outcome and winning. Of course, the random selection may not benefit the player in some situations. For example, the random selection may provide a number of hands that is unlikely to allow a player to repeat a specific outcome.

To illustrate, a Full House poker hand outcome may be expected to occur once every 40 hands in some games. Thus, a random selection of a number of games near or above 40 would tend to benefit the player while a number of games below 40 would not. As can be seen, the random selection may add some excitement to the game which may entice player who would not otherwise play the game. For example, there may be added excitement in revealing of the random selection of the number of games and/or the moments leading up to such a reveal.

It is contemplated that the random number of games may be selected from between various minimum and maximum numbers of games. In one embodiment, the minimum and maximum numbers of games may change depending on the specific outcome the player must repeat to win. This change may occur for various reasons including to benefit the player or to benefit a gaming establishment. For example, a player may be given a random number of games less than the number of games such an outcome is likely to occur within. Alternatively, a player may be given a random number of games higher or near the number of games such an outcome is likely to occur within.

The number of subsequent games may comprise a number which is generated by a random number generator. For example, in the event a player achieves a winning outcome, a random number generated by a random number generator may be transmitted to the gaming controller. The gaming controller may use this number and indicate to the player that number of subsequent games the player has to repeat that winning outcome.

Various additional features and aspects of the invention will now be described.

In one embodiment, the player may be notified of the number of remaining “repeat” games which are available. For example, when a triggering outcome is first received, a numerical counter or value may be displayed which indicates the number of hands or games in which the player must achieve a repeat outcome (such as “Remaining Hands to Repeat: 10”). This value or counter may be decremented as each subsequent hand is played. When the number of remaining games or hands reaches one or more specified low levels, certain warnings may be provided. For example, the number of remaining games or hands may be highlighted, flash, change color or the like, to bring to the attention of the player that the number of remaining available hands or games is low. For example, the number displayed by the counter may flash or change colors when the remaining number of games or hands reaches 10% of the original number of games/hands or when the number reaches a 5 or 2 or the like. Such information may prompt the player to change their play strategy in order to more aggressively seek the repeat outcome because the player knows that so few games/hands remain.

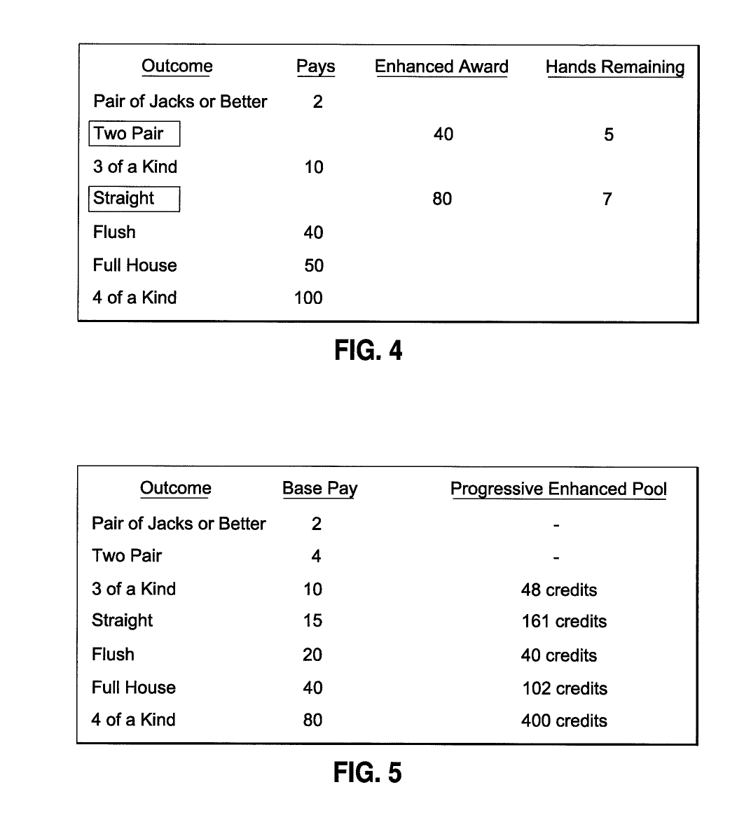

In one embodiment the base pay table or award structure may be modified in multiple ways and those modifications may “phase” in and out depending upon the specified outcomes. For example, if a player received a specified outcome such as a Full House poker hand, the pay table or award structure might be modified to that the pay table 100c illustrated in FIG. 3. The player might then have 5 games to obtain another Full House outcome and be awarded the enhanced award (of 60 times the 5× multiplier, or 300 credits). If during the next game the player received the specified outcome of Three of a Kind (which might be a winning result entitling the player to a payout or award for that particular game) then the pay table or award structure might be further modified so that the award for the Three of a Kind outcome is doubled, so long as such outcome is received in the next 5 games. If the player did not receive a Full House as a result of playing the 5 games after receiving that particular outcome, then the enhanced pay table or award structure associated with that particular result would phase out, but during the next game the enhanced pay table or award structure for the Three of a Kind would still be in effect. In such a situation, the logic or flow of the game may be modified from that in FIG. 2 so that the method includes one or more steps for implementing multiple enhanced pay tables or award structures, and for determining which such structures are in effect for particular games (as they may phase out at different times). Of course, such features may be implemented in various manners. An example of this embodiment is illustrated in FIG. 4 wherein a player has received a Two Pair triggering outcome poker hand and a Straight triggering outcome poker hand, whereby an enhanced award has gone into effect relative to each of those outcomes. As illustrated, because those triggering outcomes were received in different games, the number of hands remaining for the player to obtain a repeat of those different outcomes differs.

In other words, various enhanced pay tables or award structures might overlap for one or more games. The particular enhanced pay tables or award structures might be different. For example, upon receiving a particular outcome, the awards for particular outcomes might double. Upon receiving another outcome, that already enhanced pay table or award structure might be modified so that a multiplier applies to the already doubled awards.

In a preferred embodiment, a player is required to place a wager to place each subsequent or additional game (such as to play each hand of video poker). A player might be permitted to place a wager which entitles them to play a particular number of games. In other embodiments, a player might be permitted to play one or more subsequent games without a wager. As indicated below, however, the wagers which are required to play initial or base games may be the same or may vary from those which are required to play games for enhanced awards.

In one embodiment, a player is awarded a first winning for an outcome which triggers the enhanced award opportunity. In another embodiment, a player might only be awarded winnings for outcomes of games which do not trigger enhanced award opportunities. For example, a player might be awarded 10 credits for a Two Pair winning poker hand in a base game when no enhanced award structure is provided. However, if a player received a Three of a Kind winning poker hand for that same game, no first award might be awarded, and instead the player might only have the opportunity for an enhanced award in later game(s).

In one embodiment, certain outcomes of a game may be winning, and certain outcomes may comprise the predetermined or “triggering” outcomes, but these outcomes need not be the same. For example, as indicated, a Two Pair poker hand might be a winning outcome (such as having an associated award) but not trigger an enhanced award opportunity in later games, while a Full House poker hand might be a winning outcome with an associated award and “trigger” the opportunity for an enhanced award for one or more future game outcomes. It is also possible for a triggering outcome to only trigger the repeat opportunity and not have an associated award the first time it is received, as detailed below.

In one embodiment, the enhanced pay table or award structure may be varied over time or as games are played after the triggering event. For example, if a player is provided an opportunity to receive a specified award again during a certain number of subsequent games, the award for that outcome may change after each game in which that outcome is not received. For example, a player may receive a Full House poker hand and the pay table or award structure may be adjusted with a 5× bonus multiplier. If the player does not receive another Full House outcome in the next or subsequent game, the multiplier might be adjusted, such as reduced to “4×.” In another embodiment, the enhanced award may be decremented an amount after each game in which a specified outcome is not repeated. It is contemplated that the amount the enhanced award is decremented may be a fixed amount or a percentage or the like.

In another embodiment, the size of the enhanced award may decrease (or increase) in accordance with the odds of repeating the outcome. For example, the enhanced award for repeating the outcome on the first try (i.e., first subsequent game) might pay an enhanced award of 10 times the normal award. However, on the second attempt, the enhanced award might only pay 8 times the normal award, etc. Similarly, in the event the enhanced award comprises a progressive award or pool, the portion of the pool that the player is eligible to win may start at the full amount (or other large portion thereof) on the first subsequent game and decrease as each subsequent game is played.

The multiplier or other bonus value or other pay table or award adjustment may be pre-set (such doubling awards or a 2× multiplier) or they might vary. For example, a multiplier might be randomly generated and applied to an award. The particular award adjustments also need not be the same. For example, one award might be doubled or subject to a multiplier of 5×, while another award might be tripled or subject to a multiplier of 2×. The multiplier, bonus awards or the like might be part of game play. For example, in the play of video poker, one or more multiplier or bonus cards might be used. If one of those cards are dealt or selected, the associated multiplier or bonus might be applied.

In one embodiment, the enhanced award might comprise a secondary game, such as a free game which may yield a bonus payout. In one embodiment, the enhanced award structure might comprise larger awards for certain outcomes and reduced or no awards for other outcomes, or by increasing the number of winning outcomes (such as by making some otherwise non-winning outcomes winning outcomes for one or more future games). For example, upon receiving a specified Full House triggering outcome in a poker game, the awards for all winning outcomes with a lower rank may be reduced by 50%, but the award for a Full House may then be increased, such as by doubling or tripling it.

In one embodiment, the specified outcome may comprise a variety of events. Relative to a poker game, the specified outcome which results in an enhanced award structure may comprise other than a traditional poker hand. For example, a player may receive a particular set of cards, such as cards with the values 2, 4, 6, 8 and 10 in the 5 card positions. Then if the player receives that same set of cards in the next game or games, the player might be awarded an enhanced award. Similarly, a specified outcome may comprise a combination of slot symbols which is otherwise not a winning set of symbols but which, if received, triggers and opportunity for an enhanced award in the next game or games.

The “enhanced” awards may be funded in various manners. In one embodiment, a player may be required to place a minimum wager in order for the above-described game feature to be enabled. For example, a player might place a single credit wager to play a game of video poker. The player might be given the opportunity for the enhanced pay table or award structure if they place a 5 credit wager. In such an embodiment, the pay table for the base game may be modified to fund the enhanced award(s). For example, the payout for a winning Two Pair hand in regular video poker is two times (i.e. 2×) the wager. In accordance with the invention, the pay table of winnings for the base game may be modified to provide a payout equal to the wager (i.e. 1×) for winning Two Pair hands. In this manner, the average payout on the base award structure is reduced by 12%. This amount can be allocated to a pool for funding the enhanced awards or winnings.

In another embodiment, a player might be required to place an additional or separate wager in order to activate the enhanced award feature. All or a portion of the additional wager may be utilized to fund the enhanced awards or winnings. For example, a player may play the base game by placing a wager of between 1 and 5 credits. If the player places an additional (or 6th) credit wager, one or more of the enhanced award features described herein may be activated.

As one variation of this concept, a player may initially place a base wager to play the game in its base configuration. For example, the player might be required to place a base wager (such as 1 to 5 credits) in order to play against one or more base pay tables. If the player obtains a triggering outcome, then the player may have the option of either continuing to play games in the base configuration (base wager with base pay table) or place an enhanced wager in order to activate the enhanced award feature. For example, after receiving a Full House triggering outcome when playing a poker game in its base configuration, the player may optionally place an enhanced wager of between 6 and 10 credits to play a subsequent game in which the payout for repeating the Full House outcome is enhanced (of course, if the player is given the opportunity to repeat the Full House outcome in 10 or another number of hands, the player may elect to place an enhanced wager on each of those subsequent hands for the chance to obtain a repeat outcome and be awarded the enhanced award there for).

In one embodiment, the additional wager may entitle a player to participate relative to all potential enhanced awards. For example, if a player places the additional wager, the player may activate all potential triggering or predetermined outcomes or, such as Three of a Kind, Full House, etc. In another embodiment, a player may be required to place a particular wager to activate a particular triggering outcome and associated enhanced award. For example, a player may be required to place a 5 credit wager to play the base game, and a 6th credit wager to activate the Two Pair triggering outcome, a 7th credit wager to additionally activate the Three of a Kind triggering outcome, an 8th credit wager to additionally activate the Straight triggering outcome, a 9th credit wager to additionally activate the Flush triggering outcome, and a 10th credit wager to additionally activate the Full House triggering outcome. Thus, for example, if a player placed an 8 credit wager and received a Flush outcome, that outcome would not trigger the potential for an enhanced future award or winning.

In one embodiment, the additional wager(s) may be pooled and all enhanced awards may be funded from that pool. In another embodiment, separate pools may be created corresponding to the different triggering outcomes. For example, a Two Pair pool may be created from the 6th credit wagers, a Three of a Kind pool from the 7th credit wagers, and the like. In yet another variation, the one or more pools may be utilized to create a “progressive” enhanced award. For example, the 6th credit wagers for the Two Pair pool may fund a progressive pool that grows over time if a player does not win that pool. The progressive may be funded to a minimum level, such as 100 credits, so that the pool never drops below that amount. In such an example, wagers at one gaming machine or linked gaming machines may be utilized to fund the pools. The Two Pair pool might be at $4510.50. If a player at a first machine obtains a Two Pair outcome, then that player may be given 5 additional attempts to obtain another Two Pair outcome. In that event, the player wins that pool. However, if a player at another machine obtains the same repeat result before the first player, the second player may be awarded the pool.

In order to attract players, the progressive or other enhanced award may be increased over time. As indicated, this may be done by simply allocating a portion of one or more wagers to the enhanced award, such as to a pool. However, the award might be increased separately or for other reasons. For example, relative to the above-referenced example in which 5 additional credit wagers are needed to “activate” the Full House outcome, assume that few players are placing additional wagers of more than 2 credits. As such, the progressive or other enhanced award for the Full House outcome may not be growing. After a certain period of time, portions of wagers might be assigned to the progressive or other enhanced award for the Full House outcome so that it becomes larger, enticing players to place sufficiently high wagers to attempt to activate and then win that award.

In one preferred embodiment, the progressive award associated with one or more outcomes only grows during the time the “repeat” feature is activated. For example, relative to a progressive on a Full House outcome, the progressive award might start at 40 credits. Until a Full House outcome is received, the award might stay at 40 credits. Once the Full House outcome is received a first time and a player is given an opportunity to play for the progressive award, the progressive award may grow. For example, a player may be given 10 hands subsequent to receiving the Full House to repeat the Full House outcome in order to win the enhanced award associated therewith. During each of those 10 games, the progressive award may grow by 1 credit (or other values). Thus, if the player played 5 subsequent games, the progressive award for the Full House outcome would have grown to 45 credits. If the player receives the Full House outcome in the required 10 hands, then the player may receive the then current value of the progressive award (in this example, if on the 6^{th} hand the player received the Full House repeat outcome, the player would be awarded 45 credits). Further, in a preferred embodiment, if the player does not repeat the outcome within the defined number of games or hands, the progressive award remains at its increased level and begins to grow from that level when that outcome is later re-triggered. Of course, this feature may be applied to a single or multiple progressive awards/jackpots (such as a separate progressive jackpot for each of a plurality of designated outcomes, whereby the progressive jackpots for those outcomes may grow to different values—as illustrated in FIG. 5).

In other embodiments, the progressive or other enhanced awards may be re-distributed over time so that they do not become too uneven. For example, at certain predetermined times or based upon differentials in pool sizes or other criteria, the enhanced awards may be redistributed. As one example, the Full House enhanced award pool might have grown to $10,000 while the Two Pair enhanced award pool is only $100. A portion of the Full House pool might be allocated to the Two Pair pool to increase the repeat award for Two Pair on one or more occasions.

A player might also be permitted to win all of the enhanced awards, such as the progressive jackpot or pool associated with each outcome. For example, if a player placed the maximum wager and received one of the triggering hands (such as a Full House poker hand) and within the required number of additional games received a special hand or card or other outcome (such as A, 2, A, 2, A, in that order), the player might be entitled to the enhanced award for all outcomes.

A player might also be permitted to allocate specific wagers to particular triggering outcomes. For example, a player might place a 6th and a 7th additional wager relative to Three of a Kind. In that event, the enhanced award for repeating that outcome may be larger. For example, assuming that the player is entitled to a 100 credit enhanced award for repeating the Three of a Kind outcome when that outcome is triggered with a single additional credit wager, the player may be entitled to a 200 credit enhanced award if the outcome is repeated when it was initially triggered with a 2 additional credit wager. If the enhanced pay table or award structure is activated with a wager of a certain size (such as 2 additional credits), then the player may be required to have placed that same size wager in order to collect the enhanced award. Otherwise, the player may be paid a lesser enhanced award. For example, if the player places a 2 additional credit wager and hits a Three of a Kind and then on the next hand hits a Three of a Kind again having only placed a single additional credit wager, then the player may not be paid a double award, but only a portion thereof.

The size of a player's wager (base and/or additional wager) may determine the size of the enhanced award(s) or the level of participation therein. In one embodiment, a player may be eligible to win a portion of an enhanced award, such as a progressive pool, in proportion to the size of the player's wager. For example, a player's participation in an enhanced award might vary between from 0% to 100%. The proportion of participation may be the proportion of a player's wager relative to a maximum wager. For example, where a maximum of 5 credits may be wagered, each additional wager may increase the participation percentage by 20% (or other percentage—which may vary linearly or may vary). Thus, if a player placed a 4 credit wager in such a scenario, the player might be eligible to win 80% of the progressive pool enhanced award (for example, if a progressive pool enhanced award was at a level of $10,000.00, the player in that scenario would be awarded 80% of that value, or $8,000.00, in the event the player received the designated winning combination). Of course, the level of participation might be defined in various manners. For example, a player might be eligible to win 50% of the progressive pool if a minimum wager is placed and greater wager amounts might entitle the player to be eligible for larger amounts of the pool, up to the entire amount of the pool for a maximum wager.

In one embodiment, the enhanced award may be very large for an exact repeat. For example, a triggering outcome may be Three of a Kind poker hand. If a player received the 4♡, 4♦, and 4 [symbol] to activate the enhanced award structure and then received the exact same Three of a Kind card combination, the player might be awarded a much higher enhanced award than for other Three of a Kind card combinations. Again, the manner by which these awards are determined and financed may vary.

In one embodiment, if a particular trigger card or triggering outcome or event is received or occurs, it may increment the enhanced award or bonus relative to one or more of the outcomes. For example, each time the Ace of Spades is received, it may increment or increase the progressive bonus or other enhanced award associated with a repeat outcome of a Three of a Kind.

In one embodiment, a player's opportunity for an enhanced award may depend on other criteria, such as whether they are using a player tracking system associated with a gaming machine. Such systems are well known and have applicability to both gaming machines and table games.

In another embodiment, a player's opportunity for an enhanced award may depend upon the player receiving a special card or another event. For example, a player might receive a triggering outcome such as a winning Full House poker hand. The player may then be required to play subsequent games in until the player receives a special card. Such a card might comprise an existing card such as the Ace of Spades or a unique card added to the playing card deck (such a 53^{rd} card). If the player receives the special card during subsequent game play, then the player may be given a plurality of subsequent games or hands within which to repeat the Full House winning outcome. The payout or award for the Full House winning outcome may be enhanced over its normal or base value after the player receives the special card. Of course, other similar criteria could apply and this feature could apply to various overlapping outcomes or the other features described herein could apply.

As described above, an enhanced pay table or award structure may be applied to any future games. Thus, a first player might play a game which causes the enhanced pay table or award structure to go into effect. If that player leaves the gaming machine, table or the like, a second player may then have the opportunity to play subsequent games with the opportunity to win the enhanced award(s).

In another embodiment, an enhanced pay table or award structure is associated with a particular player. For example, a player may log into a player tracking system (such as with a card or PIN). If an enhanced pay table or award structure is in effect, the player may stop playing and log out (such as by removing their card). The gaming machine may then reset to its base mode for the next player. When the player “logs in” again, the gaming machine may reconfigure itself to offer the enhanced pay table or award structure. Of course, such may be implemented physically at a gaming table or such may be implemented in other ways.

As indicated, the adjustment may occur only for specified outcomes. For example, a pay table or award structure adjustment might be made for poker games with outcomes of Three of a Kind or better, but not simply One Pair or a Pair of a Jacks or Better. In another embodiment, the pay table or award structure adjustment might be made relative to as many as all of the designated winning outcomes (for example, from the normal winning outcomes of a Pair of Jacks or Better up through a Royal Flush).

Game information may be displayed in a various fashions. For example, the pay table or award structure may be displayed automatically, or at least when adjusted. A multiplier or bonus value might be displayed in various fashions, such as in a manner in which the values “change” and then stop at a final applied value. Progressive or bonus enhanced awards may be shown in a table or counter, so that the player is able to see the changing value of the award.

In one embodiment, if a player receives a specified outcome, the player may be entitled to select one or more outcomes to be enhanced. The player may then be provided one or later game opportunities to obtain the particular selected winning outcomes to win the enhanced awards associated therewith. The particular triggering outcome or outcome to be enhanced may be other than a specified winning outcome for the base game. For example, a player might be permitted to elect the card combination 2, 4, 6, 8, and 10 (of any suit) as an outcome which, if received and then received again (such as within a specified number of hands/turns), is entitled to an enhanced award.

In a preferred embodiment of the game, a player is required to place an enhanced wager in order to enable the enhanced award feature. For example, as detailed above, the player may play the game in its base configuration with a wager of 1 to 5 credits and enables the enhanced award feature with a wager of 6 to 10 credits. As illustrated in FIG. 6, an enhanced wager of 6 credits may enable the enhanced award feature for a Two Pair poker hand outcome, a wager of 7 credits may enable the enhanced award feature for a Three of a Kind poker hand outcome, a wager of 8 credits may enable the enhanced award feature for a Straight poker hand outcome, a wager of 9 credits may enable the enhanced award feature for a Flush poker hand outcome, and a wager of 10 credits may enable the enhanced award feature for a Full House poker hand outcome. As detailed above, the enhanced awards for each of those outcomes may be funded from the additional or enhanced wagers which enable them. In addition, the size of the enhanced awards for those outcomes may grow, such as during the time a player is playing for a repeat of that outcome. In addition, however, a portion of one or more of those enhanced wagers, such as portions of enhanced wagers between 8 and 10 credits, may be used to increase the award for one or more base game outcomes. For example, progressive award pools may be established for Four of a Kind, Straight Flush and Royal Flush outcomes. These pools may be awarded when a player receives such an outcome playing the game in its base configuration or may be awarded such an outcome when the player first receives such an outcome (i.e. the player does not have to obtain a repeat outcome to win the progressive pool award for those outcomes). In this manner, the “repeat” feature of the game and associated enhanced wagers fund larger awards for the game in its base configuration and for awards which do not have to be repeated, thus enhancing or increasing the desirability of the game overall.

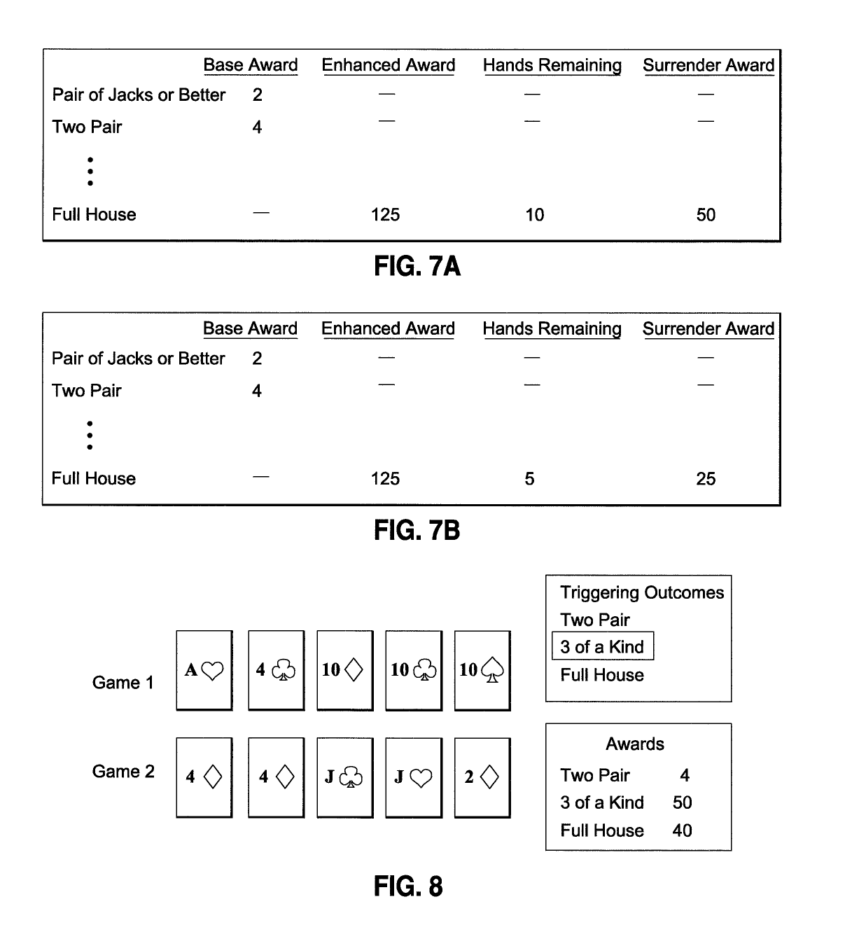

As indicated above, as one aspect of the invention a player may be given the opportunity to obtain a certain game outcome in one or more games or hands, such as a predetermined number of games subsequent to a game in which a triggering outcome was received. As one aspect of the invention, the player may be permitted to “surrender” their remaining number of games/hands in exchange for an award. For example, a player may obtain a triggering Full House poker hand outcome while playing a first game and may be awarded 25 credits. For example, as illustrated in FIGS. 7A and 7B, the player may then be given 10 subsequent games to receive the same Full House outcome and if such an outcome is repeated, may be awarded 125 credits. At one or more times, the player may be given the opportunity to surrender their chance to repeat the outcome and may preferably be paid a surrender award. The surrender award is preferably less than the award for achieving the specified outcome and may decrease based upon the number of games which are surrendered. In the above example, if the player is given 10 subsequent hands to obtain the Full House poker hand and the player elects to surrender all 10 hands, the player might be awarded 50 credits. On the other hand, the player might be awarded only 25 credits if the player played 5 subsequent hands in an attempt to achieve a Full House poker hand and surrendered only the 5 remaining hands. Of course, the award associated with the surrender, including the timing of the surrender, may vary as desired (including to entice the player to surrender or to not entice the player to surrender their opportunity for the enhanced award).

In accordance with one embodiment of the invention, a player could be paid a single award or winnings for repeating an outcome of a game. For example, relative to the game described above, a player may be required to place a wager to play a game against a table of triggering outcomes, such as illustrated in FIG. 8 relative to Game 1. If the player receives a non-triggering outcome, the game ends. If the player receives a triggering outcome, the “repeat” feature is enabled, but the player is not paid any award or winnings for the first occurrence of that outcome. Instead, upon receiving a triggering outcome while playing a first game, a pay table of winnings is then activated for one or more subsequent hands, such as illustrated in FIG. 8 relative to Game 2.

In one embodiment, the triggered pay table could comprise only the triggered outcome and an associated award. For example, if the player received a Full House triggering outcome, the activated pay table could comprise a single award solely for receiving a repeat of that Full House outcome. In other embodiments, such as illustrated in FIG. 8, the pay table could include awards for other outcomes. Awards for non-repeat outcomes could be generally smaller than those for a repeat outcome.

In one embodiment, the player could be paid a single award based upon whether the triggering outcome is received or based upon how many times the triggering outcome is repeated in the designated number of subsequent games or hands. For example, a triggering outcome in a game of poker might comprise a Full House poker hand. Once that triggering outcome is received, the player might be given 10 subsequent games or hands to try and repeat the Full House outcome as many times as possible. If the player does not repeat the Full House outcome in the subsequent number of games/hands, the player may be paid a base award, such as 25 credits. If the player repeats the Full House outcome at least one time in the subsequent number of games/hands, the player may be paid a larger award, such as 40 credits. If the player repeats the Full House outcome at least 2 times in the subsequent number of games/hands, the player may be paid an even larger award, such as 60 credits (and so on).

It will thus be appreciated that various combinations of the features or principals described above may be utilized. In such circumstances, the method of game presentation may vary from that illustrated in FIG. 2.

Another aspect of the invention is a gaming machine, device or system which is configured to present the game of the invention. In one embodiment, the gaming machine is configured to present a game, preferably in response to a player placing a wager. A controller of the machine may either generate or accept game data and display game information via a display to the player. In the event the outcome of the game is a winning outcome, the player may be awarded an award. Preferably, the controller is then configured to present one or more additional or later games using an enhanced pay table or award structure, in the manner described above. Multiple machines may be linked and associated with common progressive pools.

As also indicated above, the method of the invention may be implemented at a gaming table. For example, a game of poker may be presented to a player using physical cards. The method of play may follow that detailed above. Various aspects of the invention may be applied to other games. For example, the principles of the invention might be applied to other card games (such as Blackjack) or other games such as slots. As one example, a player might play a base game of slots and obtain a particular winning outcome such as 7-7-7. If the player repeats that outcome in a certain number of turns or games, the player may be entitled to an enhanced award (i.e. greater than the base award) for that outcome. Similarly, a player might be entitled to an enhanced award for receiving a Blackjack (A/J) combination in repeat fashion while playing such a game.

A number of aspects of the invention will now be appreciated. The game of the invention offers heightened player excitement. In a preferred embodiment of the invention, if a player receives a winning outcome in the play of a first game, the player is awarded base or normal winnings, such as in accordance with a base pay table. However, subject to the required wager and the winning outcome comprising a triggering outcome, the player is not only awarded this award, but the player is afforded the opportunity to win a larger award in the future. In a preferred embodiment, if the player repeats the winning outcome received in the first game within a defined one or more subsequent games, the player is awarded an enhanced award which is greater than the base award, for that same outcome. In this manner, a player who receives a winning outcome in the player of a game is enticed to place wagers to play additional games in an attempt to repeat the outcome in order to receive the enhanced award for that outcome.

It will be understood that the above described arrangements of apparatus and the method therefrom are merely illustrative of applications of the principles of this invention and many other embodiments and modifications may be made without departing from the spirit and scope of the invention as defined in the claims.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

What is claimed is:

1. A gaming machine comprising:
a gaming machine housing;
at least one display supported by said housing;
at least one user input device supported by said housing;
a controller configured to accept player input from said at least one user input device and present game information regarding one or more poker games having an enhanced award feature on the display;
a storage device in communication with the controller;
a paytable stored on the storage device, the paytable comprising one or more winning outcomes having one or more associated base awards;
a random number generator;
one or more instructions stored on the storage device and executable by the controller to provide the enhanced award feature, the one or more instructions comprising:
instructions for accepting a wager from a player for initiating game play;
instructions for presenting information regarding a first instance of said game to said player via said at least one display;
instructions for determining if an outcome of said first instance of said game is one of said winning outcomes;
instructions for enhancing said base award associated with said winning outcome to a larger enhanced award for subsequent games equal in number to a number generated by said random number generator;
instructions for awarding said enhanced award in the event an outcome of one of said subsequent games is a repeat of said winning outcome received in said first instance of said game;
instructions for reducing said enhanced award to a lower enhanced award greater than said base award after each of the number of subsequent games in which said winning outcome is not repeated; and
instructions for resetting the award for said winning outcome back to said base award if the player repeats the winning outcome in the number of subsequent games or if said winning outcome is not repeated in said subsequent number of games.
